(19) United States
(12) Patent Application Publication
(10) Pub. No.: US 2011/0293881 A1
(43) Pub. Date: Dec. 1, 2011

(54) METHOD FOR PRODUCING LAID FIBRE FABRICS, AND LAID FIBRE FABRICS AND THEIR USE

(75) Inventors: Florian Gojny, Thierhaupten (DE); Heide Gommel, Ditzingen (DE); Honehhes Lüken, Wettringen (DE); Peter Piechatzek, Kerpen (DE)

(73) Assignee: SGL CARBON SE, Wiesbaden (DE)

(21) Appl. No.: 13/139,011

(22) PCT Filed: Dec. 11, 2009
(86) PCT No.: PCT/EP09/66979

§ 371 Date: Aug. 15, 2011

(30) Foreign Application Priority Data
Dec. 11, 2008 (DE) 10 2008 061314.2

(51) Int. Cl. B32B 5/12; D04H 3/08; B32B 5/26

(52) U.S. Cl. 428/113; 156/181

(57) ABSTRACT

The invention relates to a method for producing a fibre layer with a longitudinal direction, wherein the method is based on the fact that fibre bundles having the same or a different fibre fineness which are guided in parallel are guided together in an overspread, overlapping manner and as a result are mechanically strengthened, wherein at least one sliver is obtained as a unidirectional layer with a defined width without additional fixing agent and/or additional mechanical or physical fixing methods.

The present invention relates to a method for producing laid fibre fabrics, and to laid fibre fabrics and the use thereof.

Laid fibre fabrics can be produced inexpensively in comparison to woven materials. At the same time, however, laid fibre fabrics have only a very poor cohesion, which makes the processing of laid fibre fabrics much more difficult, particularly on an industrial scale. In order to improve the cohesion of laid fibre fabrics, fibre layers may for example be glued, joined or knitted by fusible binding threads or bonded to one another by needling. A method for producing a composite material based on a fibre structure using a chemical binder is described for example in the patent specification FR 1 394 271.

However, the bonding of fibre layers by needling leads to laid fibre fabrics which can withstand only relatively small loads, while bonding by means of gluing or using fusible binding threads entails the risk that a sufficiently strong cohesion of the laid fibre fabric is no longer provided at higher temperatures since the glue or the fusible binding threads melt or break down. After a melting or breakdown of the glue or fusible binding threads, residues may moreover remain on the laid fibre fabric.

In the present field, therefore, there is a need to develop a method which makes it easier to produce laid fibre fabrics and in which the individual starting material components of the laid fibre fabrics are adapted to one another, as well as a need for a considerably improved laid fibre fabric in which a uniform distribution of the filaments across the width is achieved.

The problem addressed by the present invention is therefore that of producing a laid fibre fabric in which local accumulations of fibres are avoided and the final component properties are improved.

The intention is to achieve a uniform distribution of the filaments across the width by spreading filament yarn made from carbon, glass, ceramic or polymer (e.g. aramid).

The intention is to produce a material without additional fixing agent by spreading fibre bundles having the same or a different fibre fineness which are guided in parallel so as to form a sliver as a unidirectional layer over a defined width.

The laid fibre fabric according to the invention should consist of deposited fibre material in the form of fibre bundles or multifilaments and of the binding threads (e.g. knitting threads) required for joining the individual unidirectional layers.

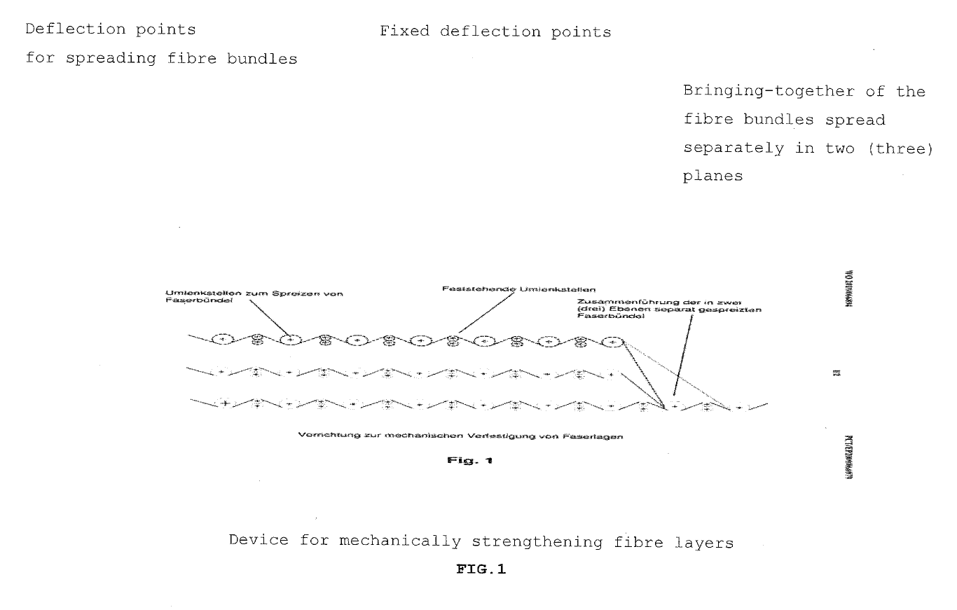

This problem is solved by a mechanical strengthening of the fibre bundle, wherein the fibre structure of the pre-laid fibres is included and used to stabilise the fibre composite. By way of example, a device for the mechanical strengthening of fibre layers is shown in FIG. 1. The number of pre-laid filament yarns according to the invention depends on the weight per unit area to be achieved in the unidirectional layer.

For adjustment purposes, the size content and the nature of the fibre surface (for example activation of the fibre surface) may optionally be adapted already during production of the fibres.

The object of the invention is therefore a method for producing a fibre layer having a longitudinal direction, wherein the method is based on the fact that fibre bundles having the same or a different fibre fineness which are guided in parallel are brought together in an overspread, overlapping manner and as a result are mechanically strengthened, wherein at least one sliver is obtained as a unidirectional layer with a defined width without application of an additional fixing agent and/or additional mechanical or physical fixing methods.

With particular preference, different titres of the fibres allow different spreading widths of the individual fibre bundles. The higher the titre, the greater the possible spreading width.

Preferably, no additional transverse adhesion has to be applied by introducing adhesive lattices or adhesive meshes. Adhesion forces are interaction forces between molecules of different substances between a plurality of phases. Adhesion forces give rise to friction, the sticking-together of different substances and wetting.

The filament yarns of the present invention are spread out in parallel alongside one another in the required number, wherein the filament yarns may also partially overlap. Filament yarns are endless threads which are generally made from synthetic, natural or inorganic raw materials, so-called filaments spun from spinnerets.

By overspreading the material, a uniform deposition of the fibre bundles is possible. Here, a fibre bundle consists of slivers which are in each case thick, linear structures composed of many fibres, e.g. preferably 5000 to 400,000 fibres and particularly preferably 50,000 fibres in the sliver cross-section.

The spreading according to the invention is carried out in a plurality of planes, preferably two to five planes, over round and/or angular deflection rollers which are mounted in a fixed position. The separately spread planes are then brought together in an overlapping manner. The course of spreading preferably takes place over heated deflection points and various devices which are able to apply heat, pressure and moisture to the material. Preferably, individual deflection points with air nozzles or suction nozzles are integrated in the process.

During the spreading, an optional overlapping of the fibres by at least 1% to at most 100% is possible, preferably from 5% to 50% and particularly preferably from 10% to 20%.

Preferably, a fibre layer consists in a proportion of more than 70% by weight, particularly preferably more than 99% by weight, of fibres selected from the group consisting of carbon fibres, precursor fibres of carbon fibres, ceramic fibres, glass fibres, polymer fibres (e.g. aramid) and mixtures thereof, relative to the total weight of the respective fibre layer.

It is preferred that at least one fibre layer has a weight per unit area in a range from 50 g/m² to 800 g/m², particularly preferably in a range from 100 g/m² to 300 g/m², wherein for example biaxial laid fibre fabrics of 200 g/m² to 600 g/m² can be produced from this particularly preferred range.

Preferably, at least one fibre bundle comprises a number of filaments in a range from 0.5 K (500 filaments) to 500 K (500,000 filaments), preferably in a range from 1 K (1000 filaments) to 400 K (400,000 filaments), particularly preferably in a range from 12 K (12,000 filaments) to 60 K (60,000 filaments).

The invention also relates to a laid fibre fabric, consisting of at least one or more unidirectional layers of different orientation, obtainable by providing an arrangement of at least one fibre layer having a longitudinal direction, which comprises unidirectional layers arranged partially or entirely on top of one another, without any need for an additional fixing agent and/or additional mechanical or physical fixing methods, and wherein at least one fibre layer consists in a proportion of more than 70% by weight, preferably more than 85% by weight, particularly preferably more than 99% by weight, of fibres selected from the group consisting of carbon fibres, precursor fibres of carbon fibres, ceramic fibres, glass fibres, polymer fibres (e.g. aramid) and mixtures thereof, relative to the total weight of the respective fibre layer. With particular preference, the unidirectional layer is applied without additional transverse adhesion.

Preference is given to laid fibre fabrics in which the different orientation of the unidirectional layers encompasses angles of −90° to +90° with the longitudinal direction of the multiaxial layer. Entangled fibre layers may also be contained in the laid fibre fabric.

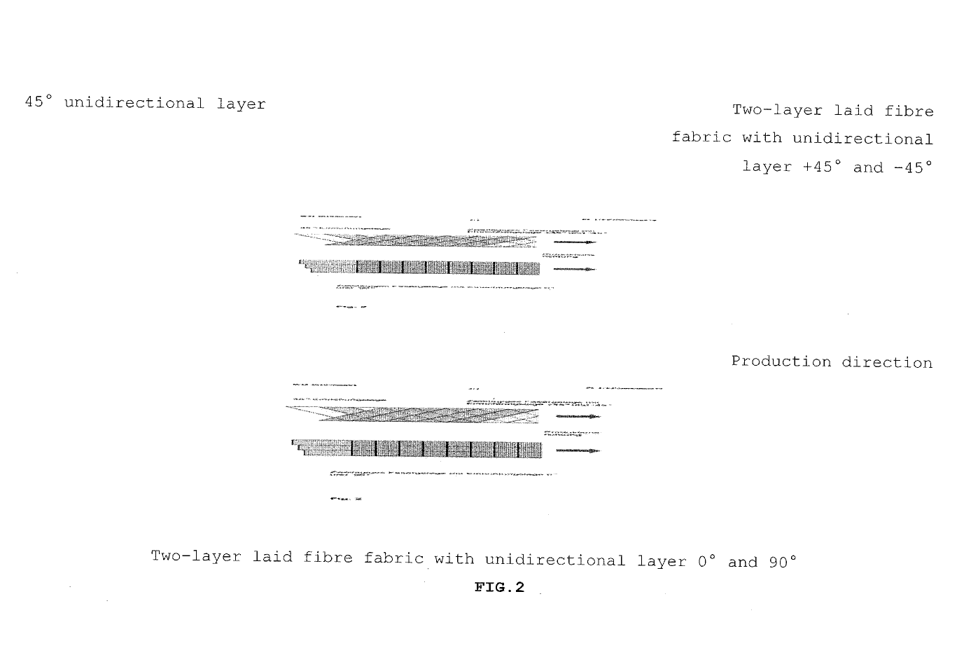

As an example, two-layer laid fibre fabrics having a unidirectional layer of +45° and −45° and having a unidirectional layer of +0° and 90° are shown in FIG. 2.

When depositing slivers in a +/−45° layer (2 layers), use is preferably made of a laid fibre fabric width of 10″-152″ (″=inch), particularly preferably 50″, and a weight per unit area of for example 300 g/m².

Preferably, entangled fibre layers, nonwovens, nonwoven materials or entangled fibre nonwoven materials and other textile structures such as for example meshes or films may be contained at the top, at the bottom or in the middle of the laid fibre fabrics.

The laid fibre fabrics are preferably used for wind turbines, for motor vehicles, ships, for air and space travel, for rail vehicles and the rest of the transport sector, for sports equipment and in the construction and building sector.

Preference is given to an element or a device, comprising a laid fibre fabric selected from the group consisting of wind turbines, motor vehicles, ships, air and space travel, rail vehicles and the rest of the transport sector, sports equipment and the construction and building sector.

The finished unidirectional layers are preferably stored in the cooled state before being supplied to the subsequent laying process.

1. Method for producing a fibre layer having a longitudinal direction, wherein the method is based on the fact that fibre bundles having the same or a different fibre fineness which are guided in parallel are brought together in an overspread, overlapping manner and as a result are mechanically strengthened, wherein at least one sliver is obtained as a unidirectional layer with a defined width without additional fixing agent and/or additional mechanical or physical fixing methods.

2. Method according to claim 1, wherein the overspreading is carried out in one or more planes over round and angular deflection rollers which are mounted in a fixed position.

3. Method according to claim 1, wherein at least one fibre layer consists in a proportion of more than 70% by weight, preferably more than 85% by weight, particularly preferably more than 99% by weight, of fibres selected from the group consisting of carbon fibres, precursor fibres of carbon fibres, ceramic fibres, glass fibres and mixtures thereof, relative to the total weight of the respective fibre layer.

4. Method according to claim 1. wherein at least one fibre layer has a weight per unit area in a range from 50 g/m² to 800 g/m², preferably in a range from 100 g/m² to 300 g/m².

5. Method according to claim 1, wherein at least one fibre bundle comprises a number of filaments in a range from 0.5 K (500 filaments) to 500 K (500,000 filaments), preferably in a range from 1 K (1000 filaments) to 400 K (400,000 filaments), particularly preferably in a range from 12 K (12,000 filaments) to 60 K (60,000 filaments).

6. Laid fibre fabric, consisting of at least one or more unidirectional layers of different orientation, obtainable by providing an arrangement of at least one fibre layer having a longitudinal direction, which comprises unidirectional layers arranged partially or entirely on top of one another, without any need for an additional fixing agent and/or additional mechanical or physical fixing methods, and wherein at least one fibre layer consists in a proportion of more than 70% by weight, preferably more than 85% by weight, particularly preferably more than 99% by weight, of fibres selected from the group consisting of carbon fibres, precursor fibres of carbon fibres, ceramic fibres, glass fibres, polymer fibres (e.g. aramid) and mixtures thereof, relative to the total weight of the respective fibre layer.

7. Laid fibre fabric according to claim 6, wherein the different orientation of the unidirectional layers encompasses angles of −90° to +90° with the longitudinal direction of the multiaxial layer.

8. Laid fibre fabric according to claim 6, wherein entangled fibre layers, nonwovens, nonwoven materials or entangled fibre nonwoven materials may be contained at the top, at the bottom or in the middle of the laid fibre fabric.

9. Use of a laid fibre fabric according to claim 6 for wind turbines, for motor vehicles, ships, for air and space travel, for rail vehicles and the rest of the transport sector, for sports equipment and in the construction and building sector.

10. Element or device, comprising a laid fibre fabric according to claim 6, selected from the group consisting of wind turbines, motor vehicles, ships, air and space travel, rail vehicles and the rest of the transport sector, sports equipment and the construction and building sector.
